(19) United States
(12) Patent Application Publication
(10) Pub. No.: US 2023/0188941 A1
(43) Pub. Date: Jun. 15, 2023

(54) LOCATION-BASED TASKS

(71) Applicant: Hewlett-Packard Development Company, L.P., Spring, TX (US)

(72) Inventors: Galo Gimenez Palop, Boise, ID (US); Cassio Fernando Berra, Porto Alegre (BR)

(21) Appl. No.: 17/996,089

(22) PCT Filed: Apr. 16, 2020
(86) PCT No.: PCT/US2020/028421

§ 371 Date: Oct. 13, 2022

(51) Int. Cl. H04W 4/029; H04W 4/021; G06F 9/48

(52) U.S. Cl. CPC H04W 4/029; H04W 4/021; G06F 9/4806

(57) ABSTRACT

Examples are described herein for location-based task performance. In various examples, it may be determined that a location of a computing device of a distributed computing system satisfies a location criterion. Based on satisfaction of the location criterion, a task associated with the location criterion may be identified. Performance of the task may be shifted from a location-agnostic computing device of the distributed computing system to the computing device.

### BACKGROUND

A distributed computing system may include a plurality of computing devices that cooperate to perform various tasks. In some cases the distribution of tasks across these computing devices is abstracted from end users of these devices. This paradigm is often referred to as “cloud” computing.

### BRIEF DESCRIPTION OF THE DRAWINGS

Features of the present disclosure are illustrated by way of example and not limited in the following figure(s), in which like numerals indicate like elements.

FIG. 1 is a schematic drawing of an example hierarchal distributed computing system in which selected aspects of the present disclosure may be implemented.

FIG. 2 schematically depicts one example of how different computing devices may perform location-based tasks.

FIG. 3 schematically depicts another example of how different computing devices may perform location-based tasks.

FIG. 4 depicts an example method of practicing selected aspects of the present disclosure.

FIG. 5 depicts a non-transitory computer-readable medium that stores computer-readable instructions for carrying out selected aspects of the present disclosure

FIG. 6 depicts an example computer architecture.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Additionally, it should be understood that the elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

Some distributed (e.g., cloud) computing systems are hierarchal. At one end of a hierarchal distributed computing system, a relatively small number of central computing devices, or servers, may be relatively unconstrained in terms of computing resources such as memory and processing cycles. At the other end, or “edge,” of the hierarchal distributed computing system, are a relatively large number of endpoint computing devices or nodes, such as edge servers (also referred to as “micro-datacenters”) or endpoint computing devices, which may be relatively constrained in terms of computing resources, especially compared to the central servers. Between may lie any number of “tiers” of intermediate computing devices. In some cases, the intermediate and endpoint computing devices can number in the tens of thousands.

Potential bottlenecks of a hierarchal distributed computing system include the network bandwidth and latency between the central servers and the edge. Accordingly, workloads may be shifted closer to the edge, particularly to edge server(s), in order to mitigate against these network bottlenecks. However, different edge servers and/or endpoint devices may tend to engage with different resources provided by the hierarchal distributed system. It may not be practicable to shift all workloads to all edge servers.

Examples are described herein for location-based task performance, particularly in a hierarchal distributed computing system. In various examples, position coordinates of a computing device such as an endpoint node or end server may be compared to a location criterion, such as being located within a predefined geo-fence. If the location criterion is met, in some examples, performance of a task associated with this location criterion may be delegated to the computing device.

In some examples in which the computing device is an endpoint computing device—particularly a mobile device such as a mobile phone, unmanned aerial vehicle (“UAV”), an autonomous vehicle, etc.—the endpoint computing device's position coordinate may be continuously and/periodically compared to the location criterion. On satisfaction of the location criterion, the endpoint computing device may perform some task or otherwise change its functionality. The task may include, for instance, a distributed computing task that the endpoint computing device performs in cooperation with other endpoint computing device(s) of the hierarchal distributed computing system that also satisfy the location criterion. For example, the other computing device may include a server application that can serve a corresponding client application executing on the endpoint computing device.

In other cases, the endpoint computing device may perform an existing task with new constraints upon satisfaction of the location criterion. For example, if the endpoint computing device is a UAV, it may update operational constraint(s), e.g., to bound travel of the UAV within a predefined two-dimensional or three-dimensional space.

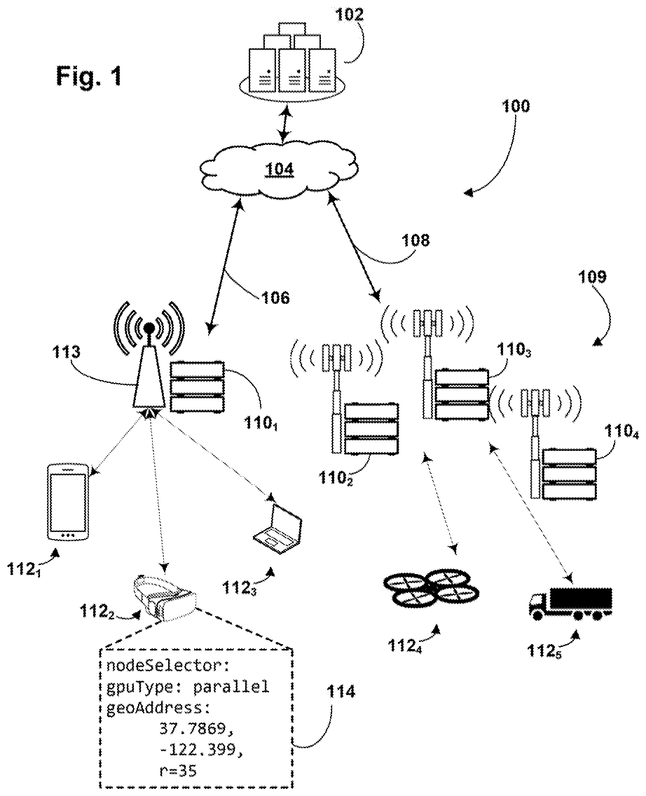

FIG. 1 is a schematic drawing of an example hierarchal distributed computing system 100 on which selected aspects of the present disclosure may be implemented. The computing devices, systems, and/or components depicted in FIG. 1 may include various forms of logic or circuitry for performing selected aspects of the present disclosure. This logic/circuitry may include, for instance, a microprocessor that executes computer-readable instructions stored in memory, an application-specific integrated circuit (“ASIC”), a field-programmable gate array (“FPGA”), etc.

Hierarchal distributed computing system 100 includes a relatively small number of high-powered computing devices that will be referred to herein as central server(s) 102. Central server(s) 102 may include any number of computing devices such as blade or rack servers that cooperate to perform various tasks. In some examples, central server(s) 102 may form the “brain” of a cloud computing environment implemented by hierarchal distributed computing system 100.

In many cases, central server(s) 102, individually and/or collectively, have relatively powerful computing resources (e.g., processing cycles, memory, etc.), especially compared to other computing devices forming part of hierarchal distributed computing system 100. For example, in FIG. 1, a next or intermediate “tier” of hierarchal distributed computing system 100 may include any number of what will be referred to herein as “edge” servers 110.

In FIG. 1 there are four edge servers 110₁₋₄, but this is not meant to be limiting, and there may be any number of edge servers 110. More generally, while three general tiers are depicted in FIG. 1 (central server(s) 102→edge servers 110→endpoint computing devices 112), this is not meant to be limiting. A hierarchal distributed computing system can include any number of tiers.

Edge servers 110 often may be somewhat constrained in computing resources compared to central server(s) 102. However, hierarchal distributed computing system 100 may include a considerably greater number edge servers 110 than central server(s) 102. For example, there may be tens or dozens of central server(s) 102 that may or may not be co-located on server farm(s) (e.g., temperature-controlled facilities that host any number of high-powered computing systems). By contrast, hierarchal distributed computing system 100 may, at any given point in time, include hundreds or even thousands of edge servers 110. These numbers of illustrative and are not meant to be limiting.

Central server(s) 102 may be operably coupled (e.g., in network communication) with edge servers 110₁₋₄ via network(s) 104. Network(s) 104 may include a local area network (“LAN”), a wide area network (“WAN”), or any combination thereof. In some cases, network(s) 104 may include primarily or wholly wired network connections because, in many such cases, communication speed and bandwidth between central server(s) 102 and edge servers 110₁₋₄ should have a relatively high capacity, robust quality of service, low latency, etc. In some cases, network(s) 104 may be referred to as “backbone” networks. For example, one network connection 106 may include a fiber optic cable (or multiple fiber optic cables). Another network connection 108 may include a copper wire. And so forth.

Edge servers 110₁₋₄ may be associated with various types of wireless communication points. For example, edge server(s) 110₁ is associated with an Institute of Electrical and Electronic (“IEEE”) 802.11x (Wi-Fi) or 802.11ax (Wi-Fi 6) wireless access point 113. Additional edge servers 110₂₋₄ are associated with a cellular network 109 that includes cellular towers. A coordinated group of edge servers 110 may in some cases be referred to as a “mini-data center.” The cellular towers may employ various types of wireless communication technology, including but not limited to General Packet Radio Service (“GPRS”), Long Term Evolution (“LTE”), Evolution Data Optimized (“Ev-DO”), Evolved High Speed Packet Access (“HSPA-F”), Global System for Mobile Communications (“GSM”), Enhanced Data rates for GSM Evolution (“EDGE”), derivatives thereof, as well as any other wireless protocols that are designated as 3G, 4G, 5G, and beyond.

A number of computing devices that will be referred to herein as “endpoint” computing devices 112 (e.g., because they are operated by end users and/or do not connect to additional downstream devices) may connect with and/or join hierarchal distributed computing system 100 by connecting wirelessly to an access point. In FIG. 1, for instance, endpoint computing devices 112₁₋₃ are in wireless network communication with access point 113. Endpoint computing devices 112₄₋₅ are in wireless network communication with cellular tower(s) of cellular network 109.

Endpoint computing devices 112 may take various forms and may be operated by end users (not depicted) for a variety of different purposes. First endpoint computing device 112₁ takes the form of a mobile phone. While mobile phone 112₁ is depicted in FIG. 1 as connected to a non-cellular access point 113, it should be understood that mobile phone 112₁ may also connect to/join cellular network 109. Second endpoint computing device 112₂ takes the form of a head-mounted display (“HMD”), which may provide an end user with an augmented reality (“AR”) and/or virtual reality (“VR”) immersive computing experience. Third endpoint computing device 112₃ takes the form of a laptop computer. Second and third endpoint computing devices 112₂₋₃ are also connected wireless to access point 113 in FIG. 1, but could alternatively connect to cellular network 109.

Additional endpoint computing devices 112₄₋₅ are shown in FIG. 1 wirelessly connected to cellular network 109. Fourth endpoint computing device 112₄ takes the form of an unmanned aerial vehicle (“UAV”), sometimes referred to as a “drone.” A drone may be autonomous, or may be wholly or partially controlled by human(s).

Fifth endpoint computing device 112₅ takes the form of a vehicular computing device hosted by a vehicle, in this case a semi-truck. In some examples, the vehicle in which the vehicular computing device 112₅ is deployed may be operated by a human driver. In such case, the vehicular computing device 112₅ may be operated, e.g., by the driver, to aid the driver in navigating the vehicle and/or for other purposes (e.g., controlling functions of the vehicle, providing audio entertainment, etc.). In other examples, the vehicle may be driverless (or allow a driver to relinquish control of the vehicle), in which case vehicular computing device 112₅ may autonomously drive the vehicle.

Although not depicted in FIG. 1, endpoint computing devices 112 may take a variety of other forms. For example, the endpoint computing devices 112₁₋₅ depicted in FIG. 1 are primarily mobile computing devices, but this is not meant to be limiting. Techniques described herein are equally applicable for stationary endpoint computing devices, such as desktop computing devices, set-top boxes for home entertainment systems, smart devices and/or appliances that form part of the Internet of Things (“IoT”), and so forth. Additionally, endpoint computing devices 112 may include other autonomous or semi-autonomous devices such as robots, which may or may not be capable of movement.

In various examples, various tasks may be shifted between computing devices of hierarchal distributed computing system 100 based on locations of the computing devices. For example, a location of a computing device such as an edge server 110 and/or endpoint computing device 112 may be determined, e.g., using a hardware component such as a Global Positioning System (“GPS”) sensor, from wireless triangulation, inertial measurement units (“IMU”), etc. This location may be evaluated to determine whether it satisfies a location criterion. As will be described shortly, a location criterion may be, for instance, the location being within a geo-fence.

Upon satisfaction of the location criterion by the endpoint computing device 112, a task associated with the location criterion may be identified. This task may come in numerous forms. In some examples, the task may include cooperating with other computing devices which also satisfy the location criterion to perform a distributed computing task (e.g., training or applying artificial intelligence models, performing localization and/or mapping in an area encompassed by the geo-fence, etc.).

In other examples, the task may or may not be an existing task already being performed by the endpoint computing device 112. In either case, the task may be modified to include a constraint that is imposed on computing devices that satisfy the location criterion. As one non-limiting example, a UAV such as UAV 112₄ may be constrained to operate within a bounded two-dimensional or three-dimensional space, e.g., such as a subspace of a geo-fenced area.

Once the task is identified, performance of the task may be performed by the endpoint computing device 112, or by an edge server 110. In some cases, e.g., where the task is a distributed or cloud computing task that is currently being performed near the “top” of hierarchal distributed computing system 100, e.g., by central server(s) 102, that task may be wholly or partially shifted to the edge server 110 or endpoint computing device 112 that satisfied the location criterion. In some cases, the task may be shifted from a “location-agnostic” computing device, e.g., central server(s) 102), to the location-qualifying computing device. As used herein, a computing device is “location-agnostic”—e.g., relative to a particular computing task—when it performs the task without regard to its own location. Central server(s) 102 are one example of computing devices that may perform many tasks location-agnostically.

Computing devices may be designated or “flagged” to perform location-based tasks in various ways. In some examples, an endpoint computing device 112 or edge server 110 may include, e.g., in its memory, a label or other data (e.g., an “application descriptor”) that indicates that the computing device should perform a particular task upon entering a space associated with a location criterion. This label may be detected, e.g., by the computing device itself or by another computing device (e.g., central server(s) 102) as part of a polling operation. In some examples, all or many computing devices of system 100 may include labels, such that, for instance, the labels abstract potentially large numbers of heterogeneous computing devices (e.g., 102, 110, 112). This abstraction may simplify deployment of large numbers of constantly changing computing devices as part of system 100.

As one non-limiting example of a label or application descriptor, second endpoint computing device 112₂ in FIG. 1 (which happens to be a HMD) includes, e.g., in its memory, a label 114 that provides “nodeSelector” criteria. These nodeSelector criteria determine when endpoint computing device 112₂, acting as a “node” of hierarchal distributed computing system 100, should perform a location-based task (not depicted) associated with label 114. In this example, longitude (37.7869) and latitude (−122.399) coordinates are provided alongside a radius of 35 meters, which indicates endpoint computing device 112₂ should perform whatever task is associated with label 114 whenever it enters a geo-fence that has a radius of 35 meters around the longitude/latitude coordinates.

In other examples, nodeSelector criteria and/or other data used to trigger performance of location-based tasks by computing devices 110/112 may be stored in memory of other computing devices, such as central server(s) 102 or edge servers 110. For example, an endpoint computing device 112 may include a minimal amount of information designating it as eligible to participate in location-based tasks assuming it satisfies some location criterion. When it connects to a wireless access point associated with an edge server 110 (and presumably satisfies some location criterion), the edge server 110 may determine which task(s) the endpoint computing device 112 should perform. In some examples, the edge server 110 or another computing device (e.g., central server 102) may transmit, to the endpoint computing device 112, computer-readable instructions (e.g., source code, compiled object code, script(s), interpreted code, bytecode, etc.) that the endpoint computing device 112 can execute to carry out the location-based task. Similarly, the endpoint computing device 112 may request and/or download the computer-readable instructions to carry out the location-based task.

Location criteria may take various forms. As noted previously, in some examples, location criteria may take the form of longitudinal and latitudinal coordinates (e.g., a geotag), and may or may not be accompanied by a radius (if a designed radius is absent, there may be a default). In some examples, a geotag may include additional information besides latitude and longitude, such as altitude, bearing, distance, timestamp(s), accuracy data, etc.

In some such examples, this additional information may also be used to determine whether a computing device should perform a location-based task. For example, a UAV (e.g., 112₄) may be expected to perform a particular task while it hovers in place (e.g., no bearing) within a predetermined altitude range, e.g., within a geo-fence or otherwise. The UAV may perform a different task when its bearing satisfies a location criteria bearing (e.g., capture aerial photos while its bearing matches a particular trajectory).

In other examples, location criteria may define a geo-fence having a polygon shape, rather than a circular or elliptical shape. For example, a geo-fence may be defined by a sequence of points, e.g., with each point defined by a latitude and longitude pair. Those points may be used as vertices, and may be connected to each other by lines or “edges” to create a polygon of virtually any shape. As non-limiting examples, polygon geo-fences may be formed as squares, rectangles, pentagons, triangles, convex polygons, concave polygons, equilateral, equiangular, and so forth. As was the case with previous examples, other location criteria such as altitude, bearing, etc., may be incorporated with polygon geo-fences.

In yet other examples, a street address may be used as location criteria, e.g., to define a geo-fence. For example, a street address may include information such as a locality name (e.g., city, town), region/state/county/country, postal code (e.g., ZIP code), and so forth. This information may be usable to define, for instance, a geo-fence of any shape that is centered at the address.

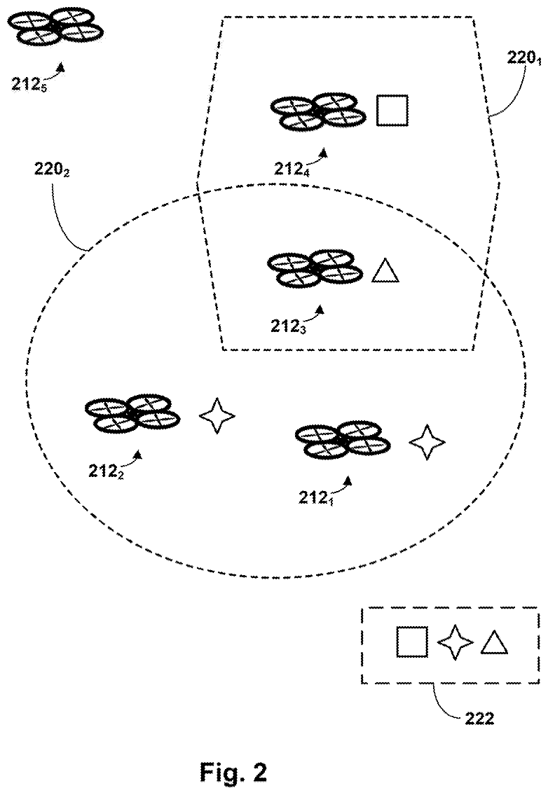

FIG. 2 schematically depicts an example in which multiple geo-fences 220₁₋₂ are defined to partially overlap each other. First geo-fence 220₁ has a polygon shape, and more particularly, is generally shaped like a hexagon. Second geo-fence 220₂ is generally elliptical. Also depicted in FIG. 2 is a library 222 of location-based tasks, with each task being represented by a different shape for illustrative purposes.

In FIG. 2, five different UAVs 212₁₋₅ are located in five different locations relative to geo-fences 220₁₋₂. First and second UAVs 212₁₋₂ are located within second geo-fence 220₂. Consequently, they both perform a first location-based task associated with first geo-fence 220₂. In FIG. 2, this location-based task associated with second geo-fence 220₂ is represented as a four-pointed star.

Fourth UAV 212₄ is located within first geo-fence 220₁. Consequently, fourth UAV 212₄ perform another location-based task (represented by a square) that is associated with first geo-fence 220₁. Fifth UAV 212₅ is located outside of either geo-fence. Consequently, fifth UAV 212₅ does not perform any location-based tasks in library 222. Third UAV 212₃ is located within both first and second geo-fences 220₁₋₂. Consequently, third UAV 212₃ performs a location-based task, represented by a triangle in FIG. 2, that is associated with both geo-fences 220₁₋₂. In other examples, third UAV 212₃ may perform two separate location-based tasks, represented by the square and four-pointed star in FIG. 2, in addition to or instead of the location-based task represented by the triangle.

While two overlapping geo-fences 220₁₋₂ are depicted in FIG. 2, this is not meant to be limiting. Any number of geo-fences can overlap in any number of ways. More generally, a computing device such as an endpoint computing device 112/212 or an edge server 110 can satisfy multiple location criteria at the same time.

Although many examples described herein have related to tasks associated with particular locations, this is not meant to be limiting. For example, geo-fences in particular, and location criteria in general, are not limited to static locations. In many examples they can be dynamic, e.g., centered about a moving point rather that defined around a static point. Tasks associated with these types of location criteria may therefore be location-criteria-specific, rather than strictly location-specific.

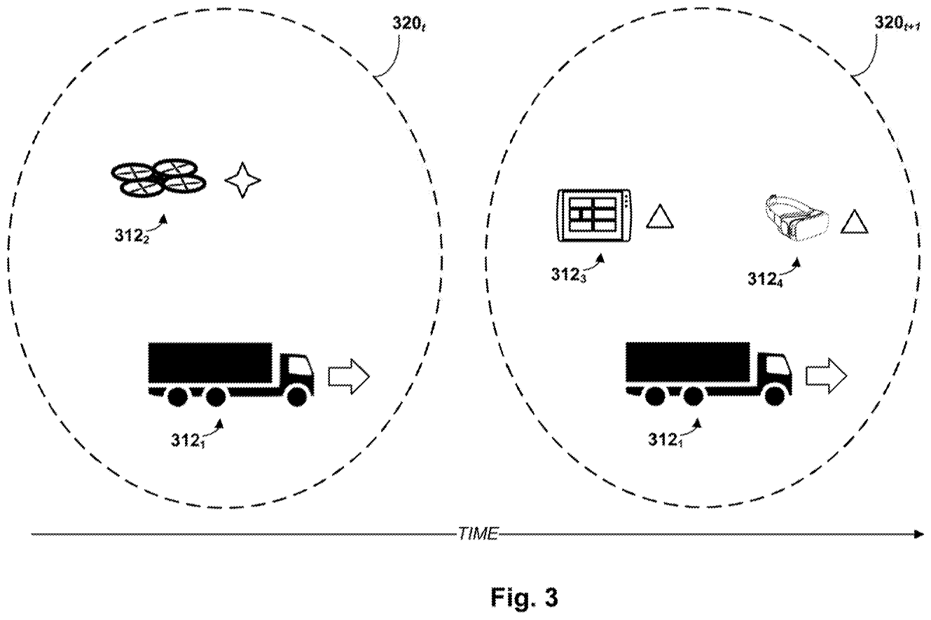

FIG. 3 depicts one such example. An endpoint computing device in the form of a vehicular computing device 312₁ is integral with a truck. In this example, the truck is travelling from left to right on the page. A geo-fence 320 is defined around, and moves with, the truck. For example, the geo-fence 320 may be dynamically defined by a current position coordinate of the truck, e.g., generated by a GPS sensor of the truck. Thus, as the truck's position changes, so does the geo-fence's center. In FIG. 3, the truck is depicted at two points in time, t and t+1 (time moves from left to right, too). Accordingly, geo-fence 320 is depicted at the two different times as the truck travels, e.g., at 320ₜ, and 320ₜ₊₁.

During time=t, a single UAV 312₂ is captured within geo-fence 320ₜ. For example, the truck may temporarily pass underneath and/or within a range of UAV 312₂. Consequently, UAV 312₂ performs a task represented by a four-pointed star. This particular task may be associated with geo-fence 320, and in some cases it may also be associated with other criteria beside location criteria. For example, the task represented by the four-pointed star may also be intended for performance by UAVs in particular, rather than other types of endpoint computing devices. For example, the task may be for UAV 312₂ to fly within two-dimensional or three-dimensional bounded area(s) that exclude the truck as it passes by.

At time=t+1, depicted on the right in FIG. 3, different tasks may be assigned to different types of endpoint computing devices that are temporarily captured by geo-fence 320ₜ₊₁. In this example; two endpoint computing devices 312₃₋₄ in the form of a tablet computer and HMD, respectively, are captured within geo-fence 320ₜ₊₁ as the truck passes nearby. These devices 312₃₋₄ are fundamentally different than UAV 312₂; and therefore the tasks (represented by triangles) they perform in response to being captured within geo-fence 320ₜ₊₁ are different than the task (captured by the four-pointed star) performed by UAV 312₂ when it was captured by geo-fence 320ₜ.

As an example, the vehicular computing device 312₁ integral with the truck may transmit computer-readable instructions for performing a task to any eligible/participating computing device that is captured within geo-fence 320. This task may include, for instance, rendering digital content (e.g., promotional materials, advertisement, etc.) visually or audibly for consumption by a user. Thus, at time=t+1 computing devices 312₃₋₄ may, when captured within geo-fence 320ₜ₊₁, receive and render digital content to their respective users.

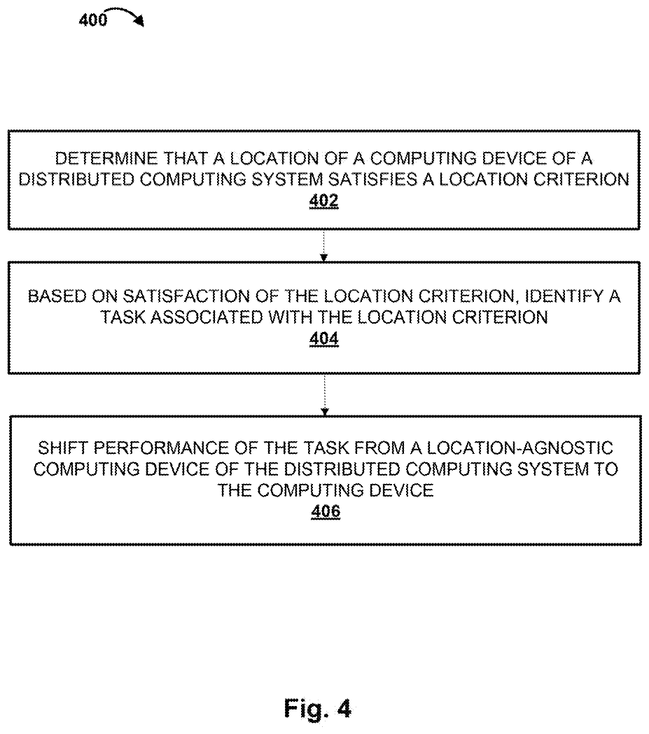

FIG. 4 depicts an example method 400 of practicing selected aspects of the present disclosure. For convenience, operations of method 400 will be described as being performed by a system configured with selected aspects of the present disclosure. The operations in FIG. 4 are not meant to be limiting; various operations may be added, omitted, and/or reordered.

At block 402, the system may determine that a location of a computing device associated with (e.g., eligible to participate in) a distributed computing system such as hierarchal distributed computing system 100 satisfies a location criterion. For example, the computing device's GPS coordinates may fall within a geo-fence defined by location criteria.

Based on satisfaction of the location criterion at block 402; at block 404, the system may identify a task associated with the location criterion. These tasks may be imposed or otherwise delegated to computing devices that, among other things, satisfy the location criterion. In many cases there may also be other, non-location-related criteria that are used to identify the tasks at block 404. For example; in addition to satisfying a location criterion, the task may also require that the computing device have certain characteristics and/or capabilities, such as being a UAV, a HMD, having sufficient or particular types of computing resources, etc.

At block 406, the system may shift performance of the task identified at block 404 from a location-agnostic computing device of the distributed computing system—e.g., central server(s) 102 of hierarchal distributed computing system 100—to the computing device determined to have satisfied the location criterion. Alternatively, in other examples in which no computing device is performing the task, the task may simply be delegated to the computing device. Or, as mentioned previously, the task may include continuing to perform an existing task of the computing device, but with additional constraints (e.g., spatial boundaries for a UAV). The task performed at block 406 may take other forms as well. In some examples, the task may be performing a portion of a distributed computing task in parallel with other endpoint computing devices that satisfy the location criterion.

Alternatively, in some examples, the task may take the form of a server application, in which case the computing device may be an edge server 110. For example, the edge server 110 may be newly-installed in (or moved to) an area that happens to satisfy the location criterion. In some such examples, the task performed by the edge server 110 may be to serve corresponding client applications on a plurality of endpoint computing devices, e.g., endpoint computing devices that also satisfy the same location criterion or another location criterion.

As one non-limiting example, suppose an online game is especially popular in a particular geographic area, and less popular elsewhere. Suppose further that hierarchal distributed computing system 100 is physically distributed across multiple different geographic areas, including the one in which the online game is popular. Edge servers 110 deployed as part of hierarchal distributed computing system 100 may include labels and/or computer-readable instructions for acting as a game server for the online game, so long as they satisfy location criteria that, for instance, define a geo-fence in the geographic area in which the online game is popular.

Thus, an edge server 110 installed within that geo-fence may, by virtue of its satisfying the location criterion, operate a gaming server node to serve local gaming clients operating on local endpoint computing devices 112. A different edge server installed in a different geographic area may still include the same label and/or computer-readable instructions for perform that task. However, because the different edge server doesn't satisfy the location criterion, it may not act as a gaming server for the online game. In this way, resources deployed as part of hierarchal distributed computing system can be abstracted to, and operated based on, their ultimate physical location.

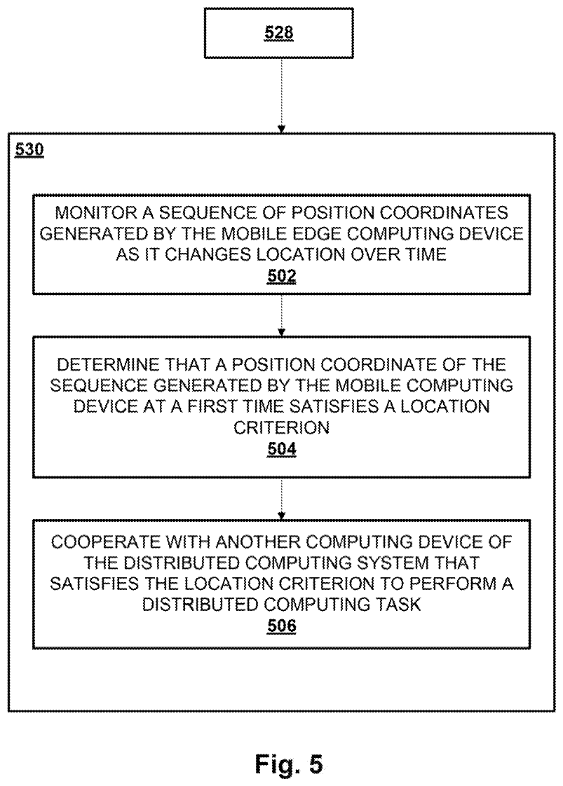

FIG. 5 depicts a non-transitory computer-readable medium 530 that includes computer-readable instructions 502-506 that are performable by a processor 528 to perform selected aspects of the present disclosure. The computer-readable instructions 502-506 in FIG. 5 are not meant to be limiting; various instructions may be added, omitted, and/or reordered. In some examples, computer-readable medium 530 and processor 528 may be integral with a mobile computing device such as a smart phone, smart glasses, UAV, vehicular computing device, etc. A mobile computing device may be contrasted with a computing device that isn't moved at all, or often, such as a desktop computer, workstation, server computer, etc.

Instructions 502 may be executed by processor 528 to monitor a sequence of position coordinates generated by the mobile computing device as it changes location over time. For example, GPS coordinates may be generated periodically and/or continuously, and may be sampled periodically and/or in response to various events to determine a current location of the mobile computing device.

Instructions 504 may be executed by processor 528 to determine that a position coordinate of the sequence generated by the mobile computing device at a first time satisfies a location criterion. For example, a sampled GPS coordinate may satisfy location criteria that corresponds to the mobile computing device being contained within a geo-fence defined by the location criteria.

Instructions 506 may cause processor 528 to, in response to the determination that the position coordinate satisfies the location criterion, cooperate with another computing device of the distributed computing system that satisfies the location criterion to perform a distributed computing task. For example, the mobile computing device may begin performing calculations in parallel with calculations performed by other mobile computing devices that also satisfy the location criteria.

In some examples, the mobile computing device may already include the computer-readable instructions for performing its portion of the distributed computing task. In other examples, the mobile computing device may be provided with computer-readable instructions for performing its portion of the distributed computing task upon satisfying the location criterion.

Although not depicted in FIG. 5, in some examples, a mobile computing device (or more generally, any computing device) may, at some point, no longer satisfy the location criterion. For example, the mobile computing device may travel outside of or exit a geo-fence defined by the location criterion. In such case, the processor 528 may execute additional instructions (not depicted) to determine that another position coordinate of the sequence generated by the mobile computing device at a second time fails to satisfy the location criterion. In response to this determination, the mobile computing device may cease cooperation with the other computing device to perform the distributed computing task.

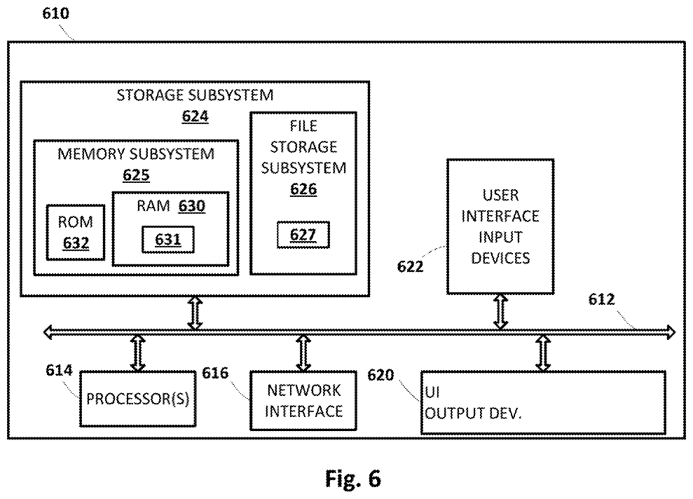

FIG. 6 is a block diagram of an example computer system 610. Computer system 610 may include a one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include input devices such as a keyboard, pointing devices such as a mouse, trackball, a touch interaction surface, a scanner, a touchscreen incorporated into the display, audio input devices such as voice recognition systems, microphone(s), vision sensor(s), and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores machine-readable instructions and data constructs that provide the functionality of some or all of the modules described herein. These machine-readable instruction modules are executed by processor 614 alone or in combination with other processors. Memory 625 used in the storage subsystem 624 may include a number of memories.

For example, a main random access memory (“RAM”) 630 may be used during program execution to store, among other things, instructions 631 for performing tasks associated with satisfaction of location criteria as described herein. Memory 625 used in the storage subsystem 624 may also include a read-only memory (“ROM”) 632 in which fixed instructions are stored.

A file storage subsystem 626 may provide persistent or non-volatile storage for program and data files, including instructions 627 for performing tasks associated with satisfaction of location criteria as described herein, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 626, or in other machines accessible by the processor(s) 614.

Bus subsystem 612 provides a mechanism for letting the various components and subsystems of computer system 610 communicate with each other as intended. Although bus subsystem 612 is shown schematically as a single bus, other implementations of the bus subsystem may use multiple busses.

Computer system 610 may be of varying types including a workstation, server, computing cluster, blade server, server farm, or any other data processing system or computing device. Due to the ever-changing nature of computers and networks, the description of computer system 610 depicted in FIG. 6 is intended as a specific example for purposes of illustrating some implementations. Many other configurations of computer system 610 are possible having more or fewer components than the computer system depicted in FIG. 6.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A method implemented using a processor, comprising:
determining that a location of a computing device of a distributed computing system satisfies a location criterion;
based on satisfaction of the location criterion, identifying a task associated with the location criterion; and
shifting performance of the task from a location-agnostic computing device of the distributed computing system to the computing device.

2. The method of claim 1, wherein the distributed computing system is a hierarchal distributed system, and the computing device comprises an edge server of the hierarchal distributed computing system, wherein a plurality of endpoint computing devices connect to the edge server.

3. The method of claim 2, wherein the task comprises a server application to serve corresponding client applications on the plurality of endpoint computing devices.

4. The method of claim 1, wherein the computing device comprises an autonomous vehicle.

5. The method of claim 1, wherein the location criterion comprises a geo-fence.

6. The method of claim 1, further detecting a label associated with the computing device, wherein the label indicates that the computing device should perform the task upon entering a space associated with the location criterion.

7. The method of claim 1, wherein the computing device is a mobile computing device, and the determining includes determining that the mobile computing device has entered a space associated with the location criterion.

8. The method of claim 1, wherein the shifting comprises transmitting, to the computing device, computer-readable instructions that are executable by the computing device to perform the task.

9. A non-transitory computer-readable medium comprising instructions that, in response to execution of the instructions by a processor of a mobile computing device of a distributed computing system, cause the processor to:
monitor a sequence of position coordinates generated by the mobile computing device as it changes location over time;
determine that a position coordinate of the sequence generated by the mobile computing device at a first time satisfies a location criterion; and
in response to the determination that the position coordinate satisfies the location criterion, cooperate with another computing device of the distributed computing system that satisfies the location criterion to perform a distributed computing task.

10. The non-transitory computer-readable medium of claim 9, further comprising instructions to:
determine that another position coordinate of the sequence generated by the mobile computing device at a second time fails to satisfy the location criterion; and
in response to the determination that the another position coordinate fails to satisfy the location criterion, cease cooperation with the another computing device.

11. The non-transitory computer-readable medium of claim 10, wherein the mobile computing device comprises:
a mobile phone;
a vehicular computing device; or
an unmanned aerial vehicle (“UAV”).

12. The non-transitory computer-readable medium of claim 11, wherein the distributed computing system is a hierarchal distributed computing system, and the another computing device comprises an edge server of the hierarchal distributed computing system.

13. A computing device, comprising:
a processor operably; and
memory operably coupled to the processor, wherein the memory stores instructions that, in response to execution of the instructions by the processor, cause the processor to:
obtain, from data generated by a hardware component of the computing device, a position coordinate;
determine that the position coordinate lies within a geo-fence; and
in response to the determination, perform an existing task of the computing device within a constraint imposed on computing devices within the geo-fence.

14. The computing device of claim 13, wherein the computing device comprises an unmanned aerial vehicle (“UAV”), and the constraint comprises a bounded two-dimensional or three-dimensional space.

15. The computing device of claim 14, further comprising instructions to download, from another computing device in response to the determination, computer-readable instructions that are executable by the processor to perform the existing task within the constraint.
